(19) United States
(12) Patent Application Publication
(10) Pub. No.: US 2024/0218797 A1
(43) Pub. Date: Jul. 4, 2024

(54) COMPOSITE AIRFOIL ASSEMBLIES AND METHOD FOR MANUFACTURING THE SAME

(71) Applicant: General Electric Company, Schenectady, NY (US)

(72) Inventors: Balaraju Suresh, Bengaluru (IN); Guru Venkata Dattu Jonnalagadda, Bengaluru (IN); Sandeep Kumar, Bengaluru (IN); Nitesh Jain, Bengaluru (IN); Abhijeet Jayshingrao Yadav, Karad (IN); Nicholas Joseph Kray, Mason, OH (US)

(21) Appl. No.: 18/317,310

(22) Filed: May 15, 2023

(30) Foreign Application Priority Data
Jan. 2, 2023 (IN) 202311000124

(51) Int. Cl. F01D 5/28

(52) U.S. Cl. CPC F01D 5/28; F05D 2220/32; F05D 2230/31; F05D 2300/17

(57) ABSTRACT

Methods of manufacturing airfoil assemblies include forming an airfoil core comprising a foam to define an airfoil shape extending in a first direction and having a pressure side and a suction side extending in a second direction, the second direction being perpendicular to the first direction, between a leading edge and a trailing edge; and electroforming a metal alloy onto an exterior surface of the airfoil core to define an external airfoil shell.

### PRIORITY INFORMATION

The present application claims priority to Indian Patent Application Number 202311000124 filed on Jan. 2, 2023.

### FIELD

The present disclosure relates to airfoil assemblies, and more particularly, to composite airfoil assemblies manufactured using electroforming such as for gas turbine engines.

### BACKGROUND

A gas turbine engine typically includes a fan assembly and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel spacecraft in flight or to power a load, such as an electrical generator. In a turbofan engine, the fan assembly generally includes a fan having a plurality of airfoils or fan blades extending radially outwardly from a central hub and/or a disk. During certain operations, the fan blades provide airflow into the turbomachine and over the turbomachine to generate thrust.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine in accordance with an exemplary embodiment of the present disclosure.

FIG. 2 is a perspective view of an airfoil assembly including its internal structure in accordance with an exemplary embodiment of the present disclosure.

FIG. 3 is a cross-sectional view of the airfoil structure of FIG. 2 in accordance with an exemplary embodiment of the present disclosure.

FIG. 4 is perspective view of another airfoil assembly in accordance with an exemplary embodiment of the present disclosure.

FIG. 5 is a flowchart diagram illustrating an exemplary method of manufacturing an airfoil assembly in accordance with an exemplary embodiment of the present disclosure.

FIG. 6 is a flowchart diagram illustrating another exemplary method of manufacturing an airfoil assembly in accordance with an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The term “adjacent” as used herein with reference to two walls and/or surfaces refers to the two walls and/or surfaces contacting one another, or the two walls and/or surfaces being separated only by one or more nonstructural layers and the two walls and/or surfaces and the one or more nonstructural layers being in a serial contact relationship (i.e., a first wall/surface contacting the one or more nonstructural layers, and the one or more nonstructural layers contacting the a second wall/surface).

As used herein, the term “composite material” refers to a material produced from two or more constituent materials, wherein at least one of the constituent materials is a non-metallic material. Example composite materials include polymer matrix composites (PMC), ceramic matrix composites (CMC), chopped fiver composite materials, etc.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the term “first stream” or “free stream” refers to a stream that flows outside of the engine inlet and over a fan, which is unducted. Furthermore, the first stream is a stream of air that is free stream air. As used herein, the term “second stream” or “core stream” refers to a stream that flows through the engine inlet and the ducted fan and also travels through the core inlet and the core duct. As used herein, the term “third stream” or “mid-fan stream” refers to a stream that flows through an engine inlet and a ducted fan but does not travel through a core inlet and a core duct. Furthermore, the third stream is a stream of air that takes inlet air as opposed to free stream air. The third stream goes through at least one stage of the turbomachine, e.g., the ducted fan.

Thus, a third stream means a non-primary air stream capable of increasing fluid energy to produce a minority of total propulsion system thrust. A pressure ratio of the third stream is higher than that of the primary propulsion stream (e.g., a bypass or propeller driven propulsion stream). The thrust may be produced through a dedicated nozzle or through mixing of airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments, these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions. In other exemplary embodiments, it is contemplated that the airflow through the third stream may contribute greater than 50% of the total engine thrust (and at least, e.g., 2% of the total engine thrust) at an engine operating condition. In other exemplary embodiments, it is contemplated that the airflow through the third stream may contribute approximately 50% of the total engine thrust (and at least, e.g., 2% of the total engine thrust) at an engine operating condition.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

Certain modern fan blades are formed of composite material(s) to reduce the weight of the fan blades. However, aircraft engine components, such as fan blades, nacelles, guide vanes, etc., used in jet engine applications are susceptible to foreign object impact damage or ingestion events, such as an ice ingestion or bird strike. Moreover, fan blades formed from composite material(s) may be more susceptible to damage in such events, e.g., by blade fracture, component delamination, bending or deformation damage, or other forms of blade damage. Accordingly, improved airfoil designs for addressing one or more of the above-mentioned problems would be useful. More specifically, an airfoil assembly with a lightweight and structurally sound design that can withstand foreign object ingestion events would be particularly beneficial.

As explained herein, composite fan blades that use internal foam support may be used in gas turbine engines. However, the layup process may be resource intense and subject to inconsistencies. Moreover, the foam may have a high risk of debonding from other portions of the blade. More specifically, under certain operational loads or during an ingestion event (e.g., ice ingestion or bird strike), the foam within a composite blade may shear or otherwise lose its bond with the spar, the outer blade skin, or both. Accordingly, aspects of the present disclosure are generally directed to a light weight and cost effective airfoil utilizing the electroforming process.

According to exemplary embodiments, at least one of the spar or the body (e.g., airfoil body) can comprise an interior foam structure. A metal alloy may then be deposited on the foam structure using electroforming. The metal alloy may have uniform thickness or varied thickness at different locations of the airfoil to tailor mechanical properties, such as stiffness.

Such a composite blade construction may facilitate improved cost, weight, and performance, thus enabling fan blade weight reduction while reducing or minimizing the potential for blade deformation, debonding, failure, or other operational degradation. In addition, local blade stiffnesses may be modified and tailored by selectively designing and positioning structural reinforcements within the foam. Moreover, such constructions may improve fan blade stability to meet aeromechanical requirements, may result in an improvement in dissipation of shock wave energy due to impact loads, may provide better control of blade untwist behavior to improve the operability margins, and may improve fan blade durability.

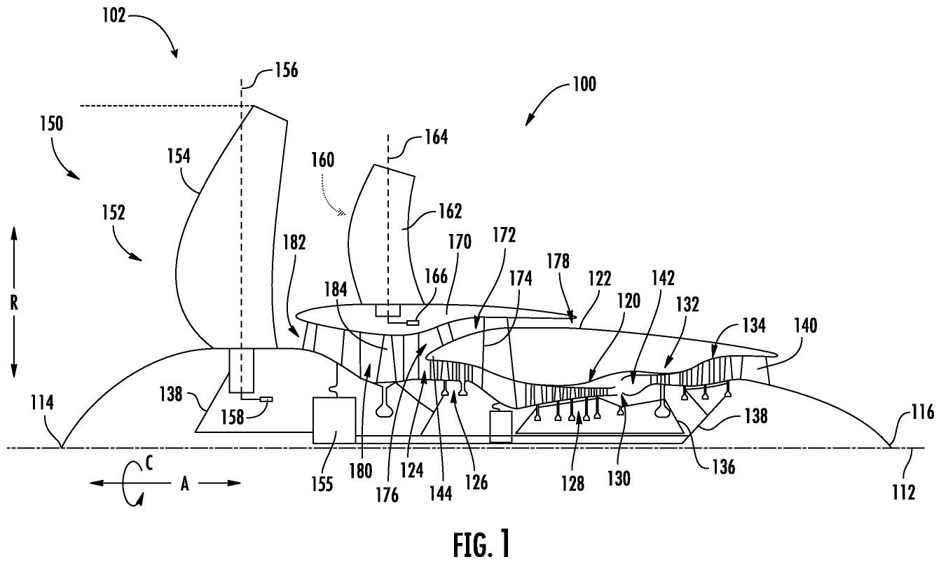

Referring now to FIG. 1, a schematic cross-sectional view of a gas turbine engine 100 is provided according to an example embodiment of the present disclosure. Particularly, FIG. 1 provides an engine having a rotor assembly with a single stage of unducted rotor blades. In such a manner, the rotor assembly may be referred to herein as an “unducted fan,” or the entire gas turbine engine 100 may be referred to as an “unducted engine,” or an engine having an open rotor propulsion system 102. In addition, the engine of FIG. 1 includes a mid-fan stream extending from the compressor section to a rotor assembly flowpath over the turbomachine, as will be explained in more detail below. It is also contemplated that, in other exemplary embodiments, the present disclosure is compatible with an engine having a duct around the unducted fan. It is also contemplated that, in other exemplary embodiments, the present disclosure is compatible with a turbofan engine having a third stream as described herein.

For reference, the gas turbine engine 100 defines an axial direction A, a radial direction R, and a circumferential direction C. Moreover, the gas turbine engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The gas turbine engine 100 extends between a forward end 114 and an aft end 116, e.g., along the axial direction A.

The gas turbine engine 100 includes a turbomachine 120, also referred to as a core of the gas turbine engine 100, and a rotor assembly, also referred to as a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through the annular core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air and produce high energy combustion products.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a core or turbomachine exhaust nozzle 140.

Accordingly, the turbomachine 120 defines a working gas flowpath or core duct 142 that extends between the annular core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. The fan 152 can be directly coupled with the LP shaft 138, e.g., in a direct-drive configuration. However, for the embodiments shown in FIG. 1, the fan 152 is coupled with the LP shaft 138 via a speed reduction gearbox 155, e.g., in an indirect-drive or geared-drive configuration.

Moreover, the fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about their respective central blade axis 156, e.g., in unison with one another. One or more actuators 158 are provided to facilitate such rotation and therefore may be used to change a pitch the fan blades 154 about their respective central blade axis 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about their respective central blade axis 164, e.g., in unison with one another. One or more actuators 166 are provided to facilitate such rotation and therefore may be used to change a pitch of the fan guide vane 162 about their respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the gas turbine engine 100 includes both a ducted and an unducted fan which both serve to generate thrust through the movement of air without passage through at least a portion of the turbomachine 120 (e.g., the HP compressor 128 and combustion section for the embodiment depicted). The ducted fan is shown at about the same axial location as the fan blade 154, and radially inward of the fan blade 154. The ducted fan 184, for the embodiment depicted, is driven by the low pressure turbine 134 (e.g., coupled to the LP shaft 138).

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan flowpath or fan duct 172. The fan flowpath or fan duct 172 may be referred to as a third stream of the gas turbine engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl.

The gas turbine engine 100 also defines or includes an inlet duct 180. The inlet duct 180 extends between an engine inlet 182 and the annular core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R.

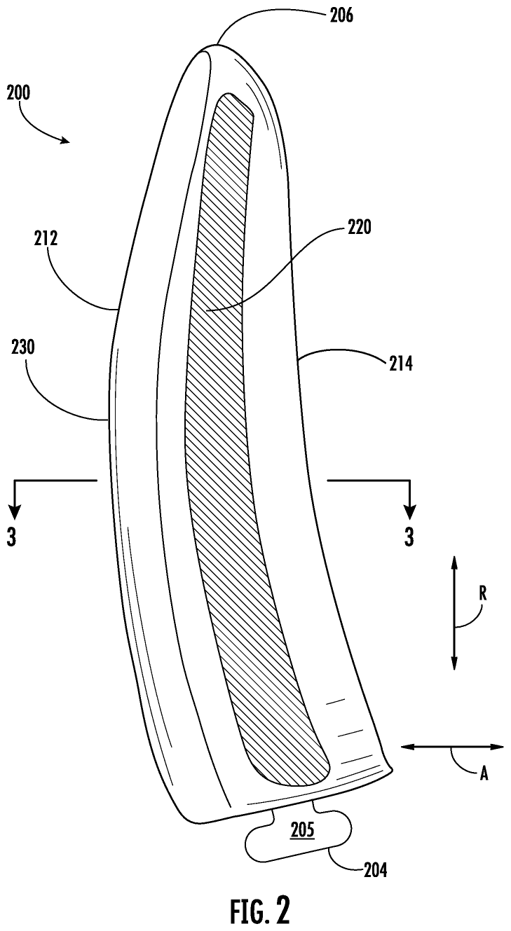

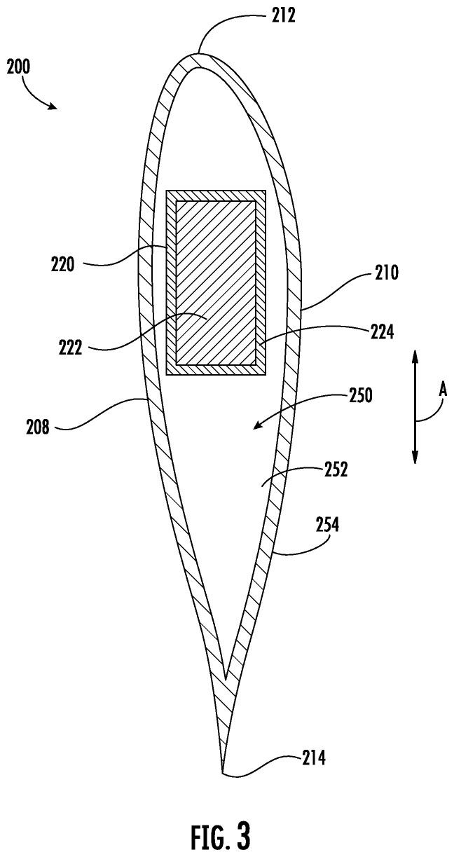

Referring now generally to FIGS. 2 and 3, airfoil assemblies 200, such as airfoil assemblies, that may be used in the gas turbine engine 100 (such as that illustrated in FIG. 1) will be described according to exemplary embodiments of the present disclosure.

Specifically, FIG. 2 provides an airfoil assembly 200, with a cutaway showing a spar 220. The airfoil assembly 200 may be used in the gas turbine engine 100 such as for a fan blade 154 or a fan guide vane 162. FIG. 3 provides a cross sectional view of the airfoil assembly 200 of FIG. 2.

Notably, due to the similarity between embodiments described herein, like reference numerals may be used to refer to the same or similar features among various embodiments. Although airfoil assemblies 200 are described herein as being used with gas turbine engine 100 (FIG. 1), it should be appreciated that aspects of the present subject matter may be applicable to any suitable blades for any suitable gas turbine engine. Indeed, the exemplary blade constructions and features described herein may be interchangeable among embodiments to generate additional exemplary embodiments. The specific structures illustrated and described herein are only exemplary and are not intended to limit the scope of the present subject matter in any manner.

The assembly 200 may generally comprise an body (e.g., an airfoil body) that extends outward along a radial direction R, e.g., which corresponds to radial direction R when airfoil assembly 200 is installed in the gas turbine engine 100 (FIG. 1). Radial direction R can also be referred to as first direction. Furthermore, as illustrated in FIG. 3, the airfoil assembly 200 includes a pressure side 208 and an opposing suction side 210 extending in an axial direction A between a leading edge 212 and a trailing edge 214. Axial direction A can also be referred to as second direction. In this respect, the pressure side 208 and the suction side 210 are joined together or interconnected at the leading edge 212 and the trailing edge 214 of the airfoil assembly 200.

In some configurations, such as that illustrated in FIG. 2, the airfoil assembly 200 may include a spar 220 to support the body. The spar 220 that extends along the radial direction R and may include a blade attachment structure 205, e.g., illustrated as a dovetail, for securing the airfoil assembly 200 to a rotating central hub (e.g., or mechanically coupling airfoil assemblies 200 to actuators 158). The spar 220 may extend outward from root 204 along the radial direction R toward the tip 206 of the airfoil assembly 200.

With reference to FIG. 3, the airfoil assembly 200 includes an airfoil core 252 and an external airfoil shell 254. The airfoil core 252 comprises a foam material. The foam material can be any foam or composite foam material or materials that are capable of retaining an airfoil shape and supporting an external shell. For instance, the foam material can comprise a thermoplastic foam, such as styrene acrylonitrile. In some embodiments, the foam material can comprise at least one of a polymethacrylimide (PMI) foam or a urethane foam. In addition, or alternatively, the foam material may also include cast syntactic or expanding syntactic foams, e.g., glass, carbon, or phenolic micro balloons cast in resin. Other suitable foams are possible and within the scope of the present subject matter.

In some embodiments, the foam material may be suitable for an electroforming process thereon. Electroforming refers to depositing a metal (or alloy) material onto an exterior surface of a substrate using electrodeposition so that the metal material can form and grow a layer on the substrate. For instance, the airfoil core 252 can be formed by pouring the foam material into a mold having sparfoil shape. In some embodiments, one or more spars 220 may be positioned in the mold before the foam is poured in. The foam can then be allowed to cure and the mold can be removed to produce the airfoil core 252. In some embodiments, the airfoil core 252 may be further shaped or sculpted into a final form. The shape and dimensions of the airfoil core 252 may be selected to provide the required properties to the airfoil assembly 200.

The body further includes an external airfoil shell 254 on an exterior surface of the airfoil core 252. The external airfoil shell 254 comprises a metal alloy electroformed on the airfoil core 252. The metal alloy may be any metal alloy amenable to electroforming. That is, the metal alloy can comprise any material suitable for electrodeposition onto the foam material of the airfoil core 252. Suitable metal alloys include nickel alloys, cobalt alloys, titanium alloys, aluminum alloys, aluminum lithium alloys, and iron alloys. In an embodiment, the nickel alloy is an alloy of nickel and a metal selected from cobalt, chromium, aluminum, titanium, molybdenum, tungsten, niobium, and tantalum, such as a nickel cobalt phosphorous alloy.

In some embodiments, the external airfoil shell 254 may cover all of the exterior surface of the airfoil core 252 and be formed entirely of an electroformed metal alloy. Alternatively, only a portion of the exterior surface may be covered by the external airfoil shell 254 or only a portion of the external airfoil shell 254 may be an electroformed metal alloy.

For instance, when only a portion of the external airfoil shell 254 is to comprise an electroformed alloy, the airfoil core 252 may be only partially submerged in the electrophoretic deposition bath or a portion of the exterior surface of the airfoil core 252 may be masked to selectively prevent electrodeposition. Such embodiments may facilitate selective electroforming in discrete locations, such as when only a portion of the airfoil assembly 200 needs an external metal alloy, or when a previously electroformed metal alloy is being repaired at select locations after wear or abrasion. Thus, it will be understood that aspects of the disclosure apply to repair of an airfoil as well as the making of an airfoil. In some embodiments, the remaining portion of the external airfoil shell 254, i.e., the portion that does not comprise the electroformed metal alloy, can comprise a composite structure such as one or more composite fibers utilized in airfoil assemblies. The composite structure can comprise, for instance, a laminate structure (i.e., layers of composite materials disposed on top of one another), a woven structure (composite fibers woven about one another into a flat sheet), or a braided structure (composite fibers braided about one another into a three-dimensional braid). When the electroformed metal alloy is utilized with the composite structure, the two adjacent areas may be monolithically or unitarily formed or joined through the deposition process.

In some embodiments, only the leading edge 212, only the trailing edge 214, or both the leading edge 212 and trailing edge 213 may have the metal alloy electroformed thereon. The rest of the airfoil core 252 could then be covered with a different material, or even the same material using a different process.

The external airfoil shell 254 will have a thickness of the metal alloy electroformed on the exterior surface of the airfoil core 252. As appreciated, the thickness can be dependent on the electroforming process parameters, including exposure time. For instance, the external airfoil shell 254 can have a thickness of 5 mils to 50 mils, or 10 mils to 40 mils, or 15 mils to 25 mils, or 15 mils to 20 mils, or 10 mils to 20 mils, or 10 mils to 25 mils.

Moreover, the thickness of the external airfoil shell 254 can be uniform (i.e., constant) across the body or may be nonuniform. For instance, the thickness of the external airfoil shell 254 may be thicker at one or more of the leading edge 212, trailing edge 214, root 204, or tip 206 locations with respect to the rest of the external airfoil shell 254. Likewise, the thickness of the external airfoil shell 254 can vary along the radial direction R, the axial direction A, or both. Having a thickness that is nonuniform may provide an airfoil assembly 200 that has varying stiffness (which can be tailored during manufacturing).

The electroforming process of the present disclosure allows for flexibility in the composition and structure of the external airfoil shell 254. The resulting airfoil assembly 200, including the body, can also have a simpler manufacturing process and a lighter overall weight than compared to an airfoil comprising composite layups. Electroforming the external airfoil shell 254 onto the airfoil core 252 can also produce external airfoil shell 254 having complex geometries, which would otherwise be difficult to produce using lamination methods.

As discussed above, and as illustrated in FIG. 3, in some embodiments, the airfoil assembly 200 may include the spar 220. The spar 220 may be formed from any suitably rigid material(s) that can withstand the forces exerted on airfoil assembly 200 during operation of the gas turbine engine 100. The spar 220 and the body can be formed of different materials to balance weight, rigidity, integrity, and cost. In an exemplary embodiment, the spar 220 is made of a material that is stronger, stiffer, and more rigid than the material of the airfoil core 252. For example, the spar 220 forms the strongest and most rigid portions of the airfoil assembly 200. Thus, integrating the spar 220 into the airfoil body can reinforce the strength of the airfoil body. In this manner, the spar 220 can carry and transfer at least a portion of the load of the airfoil assembly 200 during, for example, operation of the gas turbine engine 100 (FIG. 1). In another exemplary embodiment, the airfoil core 252 is made of a material that is softer than the material of the spar 220.

In some embodiments, the spar 220 can comprise a combination of materials manufactured using the electroforming process. For instance, the spar 220 includes a spar core 222 and an external spar shell 224.

In such embodiments, the spar core 222 can comprise a second foam suitable for the electroforming process, either the same type as or a different type from the first foam material used for the airfoil core 252. The second foam can be any foam or composite foam material or materials that are capable of supporting an external structure. For instance, the foam material can comprise a thermoplastic foam, such as styrene acrylonitrile. In some embodiments, the foam material can comprise at least one of polymethacrylimide (PMI) foam or a urethane foam. In addition, or alternatively, the foam material may also include cast syntactic or expanding syntactic foams, e.g., glass, carbon, or phenolic micro balloons cast in resin. Other suitable foams are possible and within the scope of the present subject matter

For instance, the spar core 222 can be formed by pouring the foam material into a mold. The foam can then be allowed to cure and the mold can be removed to produce the spar core 222. In some embodiments, the spar core 222 may be further shaped or sculpted into a final form. The shape and dimensions of the spar core 222 may be selected to provide the required properties to the airfoil assembly 200.

The spar 220 further includes an external spar shell 224 on a surface of the spar core 222. The external spar shell 224 comprises a metal alloy electroformed on the spar core 222. The metal alloy may be any metal alloy amenable to electroforming. That is, the metal alloy can comprise any material suitable for electrodeposition onto the foam material of the spar core 222. Suitable metal alloys include nickel alloys, cobalt alloys, titanium alloys, aluminum alloys, aluminum lithium alloys, and iron alloys. In an embodiment, the nickel alloy is an alloy of nickel and a metal selected from cobalt, chromium, aluminum, titanium, molybdenum, tungsten, niobium, and tantalum, such as a nickel cobalt phosphorous alloy. The external spar shell 224 may a second metal alloy that is the same as, or different than, the first metal alloy used for the external airfoil shell 254 when both shells are present and electroformed.

In some embodiments, the external spar shell 224 may cover all of the exterior surface of the spar core 222 and be formed entirely of an electroformed metal alloy. Alternatively, only a portion of the exterior surface may be covered by the external spar shell 224 or only a portion of the external spar shell 224 may be an electroformed metal alloy. For instance, when only a portion of the external spar shell 224 is an electroformed alloy, the spar core 222 may be only partially submerged in the electrophoretic deposition bath or a portion of the spar core 222 may be masked to selectively prevent electrodeposition. In addition, the spar core 222 may be completely covered with the electroformed metal alloy and then, subsequently, portions of the metal alloy subsequently can be selectively removed.

The external spar shell 224 will have a thickness of the metal alloy electroformed on the surface of the spar core 222. As appreciated, the thickness can be dependent on the electroforming process parameters, including exposure time. For instance, the external spar shell 224 can have a thickness of 5 mils to 50 mils, or 10 mils to 40 mils, or 15 mils to 25 mils, or 15 mils to 20 mils, or 10 mils to 20 mils, or 10 mils to 25 mils.

Moreover, the thickness of the external spar shell 224 can be uniform (i.e., constant) across the body or may be nonuniform. For instance, the thickness of the external spar shell 224 may vary along the radial direction R, the axial direction A, or both. Having a thickness that is nonuniform may provide an airfoil assembly 200 that has varying stiffness (which can be tailored during manufacturing).

The electroforming process of the present disclosure allows for flexibility in the composition and structure of the external spar shell 224. The resulting airfoil assembly 200, including the spar 220, can also have a simpler manufacturing process and a lighter overall weight than compared to an airfoil comprising composite layups. Electroforming the external spar shell 224 onto the spar core 222 can also produce a spar having complex geometries, which would otherwise be difficult to produce using other materials or manufacturing methods. Moreover, electroforming the external spar shell 224 onto the spar core 222 can enable tailoring of the external spar shell 224 such as by selectively electroforming only one or more regions.

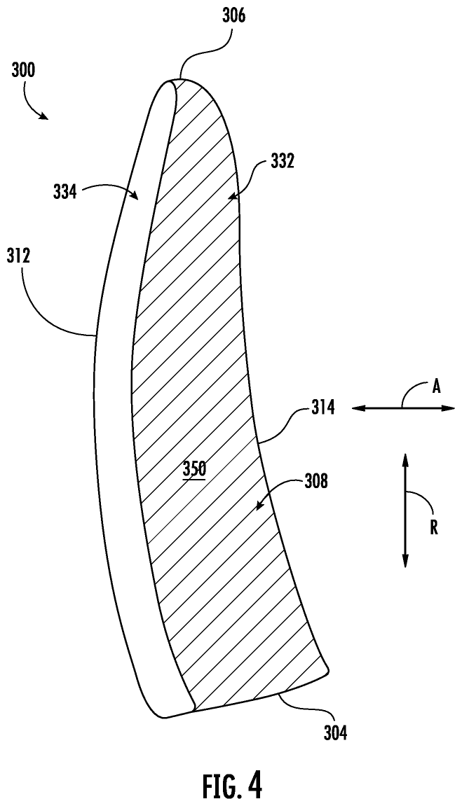

FIG. 4 illustrates another airfoil assembly 300. The airfoil assembly 300 generally includes an airfoil body that extends outward along a radial direction R, e.g., which corresponds to radial direction R when airfoil assembly 300 is installed in gas turbine engine 100 (FIG. 1). Furthermore, the airfoil assembly 300 includes a pressure side 308 and an opposing suction side (not illustrated) extending in the axial direction A between a leading edge 312 and a trailing edge 314. In this respect, the pressure side 308 and the suction side (not illustrated) are joined together or interconnected at the leading edge 312 and the trailing edge 314 of the airfoil assembly 300.

In the exemplary embodiment illustrated in FIG. 4, the external airfoil shell 354 comprising the metal alloy from electroforming only covers a portion of the outer surface 350 of the airfoil assembly 300. Specifically, only the leading edge 312 comprises the metal alloy electroformed thereon. The rest of the airfoil core 332 can either be covered with a different material, or even the same material using a different process.

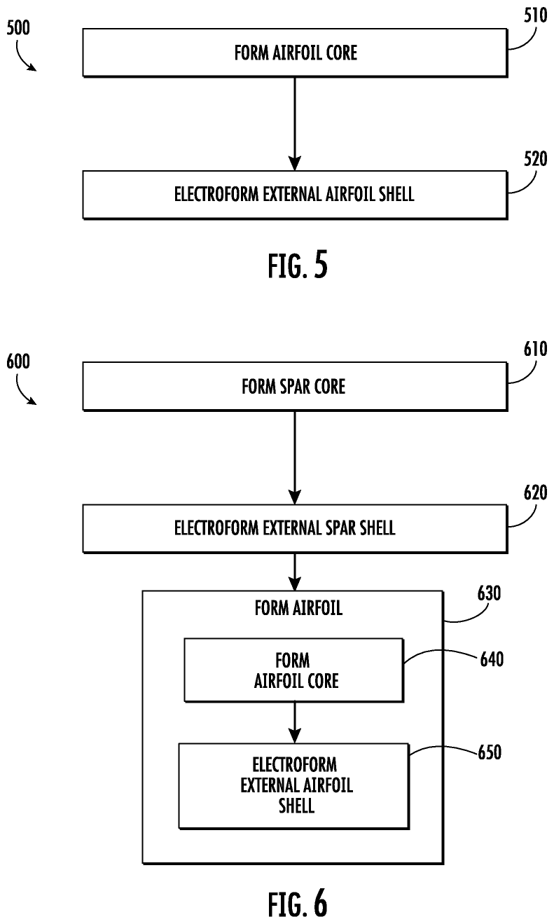

Referring now to FIG. 5, an exemplary method 500 for manufacturing an airfoil assembly will be described according to exemplary embodiments of the present subject matter. For example, method 500 may be used to manufacture airfoil assembly 200 or 300 as described above with respect to FIGS. 2-4. However, it should be appreciated that aspects of method 500 may be applied to the construction of any other suitable airfoil. In addition, it should be appreciated that alterations and modifications may be made to method 500 while remaining within scope of the present subject matter.

Method 500 may include, at step 510, forming an airfoil core comprising a foam to define an airfoil shape extending in a first direction and having a pressure side and a suction side extending in a second direction, the second direction being perpendicular to the first direction, between a leading edge and a trailing edge. For instance, the airfoil core can be formed in step 510 by pouring the foam material into a mold having an airfoil shape. In some embodiments, one or more spars may be positioned in the mold before the foam is poured in. The foam can then be allowed to cure and the mold can be removed to produce the airfoil core. In some embodiments, the airfoil core may be further shaped or sculpted into a final form.

Method 500 may further include, at step 520, electroforming a metal alloy onto a surface of the airfoil core to define an external airfoil shell. Electroforming can comprise depositing a metal (or alloy) material onto a surface of a substrate using electrodeposition so that the metal material can form and grow a layer on the substrate.

In some embodiments, the external airfoil shell may be further shaped or sculpted into a final form. For instance, the external airfoil shell may be ground, shaped, and polished to achieve a final form, as required.

Referring now to FIG. 6, another exemplary method 600 for manufacturing an airfoil assembly will be described according to exemplary embodiments of the present subject matter. For example, method 600 may be used to manufacture airfoil assembly 200 or 300 as described above with respect to FIGS. 2-4. However, it should be appreciated that aspects of method 600 may be applied to the construction of any other suitable airfoil. In addition, it should be appreciated that alterations and modifications may be made to method 600 while remaining within scope of the present subject matter.

Method 600 may include, at step 610, forming a spar core comprising a foam to define a spar extending in a first direction and, at step 620, electroforming a metal alloy onto a surface of the spar core to define an external spar shell. Similar to above, electroforming can comprise depositing a metal (or alloy) material onto a surface of a substrate using electrodeposition so that the metal material can form and grow a layer on the substrate. In some embodiments, the external spar shell may be further shaped or sculpted into a final form.

Method 600 may further include, at step 630 forming an airfoil around the external spar shell, the airfoil extending in the first direction and having a pressure side and a suction side extending in a second direction, the second direction being perpendicular to the first direction, between a leading edge and a trailing edge.

For instance, method 600 can include, at step 640, forming an airfoil core comprising a second foam around the external spar shell to define the airfoil, and at step 650, electroforming a second metal alloy onto a surface of the airfoil core to define an external airfoil shell. In such embodiments, the airfoil assembly would have both a spar and a body (e.g., an airfoil body) manufactured using the electroforming process. In some embodiments, the external airfoil shell may be further shaped or sculpted into a final form.

The methods of the present disclosure may thereby allow for smooth surface profiles, varying blade stiffness (along the span or the chord or both) and eliminate the need for external features sometimes needed with conventional materials, such as leading edge guards, certain coatings, and anti-icing mounts. Moreover, the methods of the present disclosure may reduce the mass of the airfoil by up to or greater than 25% and/or may reduce the construction cost of the airfoil by up to or greater than 20% compared to composite airfoils created with ply layup and resin combination.

Further aspects are provided by the subject matter of the following clauses:

A method of manufacturing an airfoil assembly, the method comprising forming an airfoil core comprising a foam to define an airfoil shape extending in a first direction and having a pressure side and a suction side extending in a second direction, the second direction being perpendicular to the first direction, between a leading edge and a trailing edge; and electroforming a metal alloy onto an exterior surface of the airfoil core to define an external airfoil shell.

The method of any clause herein, wherein forming the airfoil core comprises forming the airfoil core around a spar extending in the first direction.

The method of any clause herein, wherein the external airfoil shell covers all of the exterior surface of the airfoil core.

The method of any clause herein, wherein the external airfoil shell has a nonuniform thickness.

The method of any clause herein, wherein at least a portion the external airfoil shell comprises a laminate structure, a woven structure, or a braided structure.

The method of any clause herein, wherein the metal alloy comprises a nickel alloy, a cobalt alloy, a titanium alloy, aluminum alloy, aluminum lithium alloy, or an iron alloy.

The method of any clause herein, wherein the metal alloy comprises a nickel cobalt phosphorous alloy.

The method of any clause herein, wherein the external airfoil shell has a thickness of 15 mils to 20 mils.

The method of any clause herein, wherein the foam comprises a thermoplastic foam.

A method of manufacturing an airfoil assembly, the method comprising forming a spar core comprising a first foam to define a spar extending in a first direction; electroforming a first metal alloy onto a surface of the spar core to define an external spar shell; and forming an airfoil around the external spar shell, the airfoil extending in the first direction and having a pressure side and a suction side extending in a second direction, the second direction being perpendicular to the first direction, between a leading edge and a trailing edge.

The method of any clause herein, wherein forming the airfoil comprises:
forming an airfoil core comprising a second foam around the external spar shell to define the airfoil; and electroforming a second metal alloy onto a surface of the airfoil core to define an external airfoil shell.

The method of any clause herein, wherein the external spar shell has a nonuniform thickness.

The method of any clause herein, wherein the first metal alloy comprises a nickel alloy, a cobalt alloy, a titanium alloy, aluminum alloy, aluminum lithium alloy, or an iron alloy.

The method of any clause herein, wherein the external spar shell has a thickness of 15 mils to 20 mils.

The method of any clause herein, wherein the first foam comprises a thermoplastic foam.

An airfoil assembly comprising a spar extending along a first direction; an airfoil core around the spar and comprising a first foam defining an airfoil shape extending in the first direction and having a pressure side and a suction side extending in a second direction, the second direction being perpendicular to the first direction, between a leading edge and a trailing edge; and an external airfoil shell on a surface of the airfoil core, the external airfoil shell comprising a first metal alloy electroformed on the airfoil core.

The airfoil assembly of any clause herein, wherein the external airfoil shell has a nonuniform thickness.

The airfoil assembly of any clause herein, a spar core comprising a second foam to define the spar extending in the first direction; and an external spar shell on a surface of the spar core, the external spar shell comprising a second metal alloy electroformed on the spar core.

The airfoil assembly of any clause herein, wherein the external spar shell has a nonuniform thickness.

The airfoil assembly of any clause herein, wherein the external airfoil shell covers all of an exterior surface of the airfoil core.

A method of repairing an airfoil assembly, the method comprising electroforming a metal alloy onto a first portion of an exterior surface of an airfoil core; wherein the airfoil core comprises a foam to define an airfoil shape extending in a first direction and having a pressure side and a suction side extending in a second direction, the second direction being perpendicular to the first direction, between a leading edge and a trailing edge.

The method of any clause herein, further comprising masking a second portion of the exterior surface of the airfoil core prior to electroforming the metal alloy onto the first portion.

The method of any clause herein, wherein the second portion comprises a previously electroformed metal alloy.

The method of any clause herein, further comprising removing material from the first portion prior to electroforming the metal alloy onto the first portion.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of manufacturing an airfoil assembly, the method comprising:
forming an airfoil core comprising a foam to define an airfoil shape extending in a first direction and having a pressure side and a suction side extending in a second direction, the second direction being perpendicular to the first direction, between a leading edge and a trailing edge; and
electroforming a metal alloy onto an exterior surface of the airfoil core to define an external airfoil shell.

2. The method of claim 1, wherein forming the airfoil core comprises forming the airfoil core around a spar extending in the first direction.

3. The method of claim 1, wherein the external airfoil shell covers all of the exterior surface of the airfoil core.

4. The method of claim 1, wherein the external airfoil shell has a nonuniform thickness.

5. The method of claim 1, wherein at least a portion the external airfoil shell comprises a laminate structure, a woven structure, or a braided structure.

6. The method of claim 1, wherein the metal alloy comprises a nickel alloy, a cobalt alloy, a titanium alloy, aluminum alloy, aluminum lithium alloy, or an iron alloy.

7. The method of claim 1, wherein the metal alloy comprises a nickel cobalt phosphorous alloy.

8. The method of claim 1, wherein the external airfoil shell has a thickness of 15 mils to 20 mils.

9. The method of claim 1, wherein the foam comprises a thermoplastic foam.

10. A method of manufacturing an airfoil assembly, the method comprising:
forming a spar core comprising a first foam to define a spar extending in a first direction;
electroforming a first metal alloy onto a surface of the spar core to define an external spar shell; and
forming an airfoil around the external spar shell, the airfoil extending in the first direction and having a pressure side and a suction side extending in a second direction, the second direction being perpendicular to the first direction, between a leading edge and a trailing edge.

11. The method of claim 10, wherein forming the airfoil comprises:
forming an airfoil core comprising a second foam around the external spar shell to define the airfoil; and
electroforming a second metal alloy onto a surface of the airfoil core to define an external airfoil shell.

12. The method of claim 10, wherein the external spar shell has a nonuniform thickness.

13. The method of claim 10, wherein the first metal alloy comprises a nickel alloy, a cobalt alloy, a titanium alloy, aluminum alloy, aluminum lithium alloy, or an iron alloy.

14. The method of claim 10, wherein the external spar shell has a thickness of 15 mils to 20 mils.

15. The method of claim 10, wherein the first foam comprises a thermoplastic foam.

16. An airfoil assembly comprising:
a spar extending along a first direction;
an airfoil core around the spar and comprising a first foam defining an airfoil shape extending in the first direction and having a pressure side and a suction side extending in a second direction, the second direction being perpendicular to the first direction, between a leading edge and a trailing edge; and
an external airfoil shell on an exterior surface of the airfoil core, the external airfoil shell comprising a first metal alloy electroformed on the airfoil core.

17. The airfoil assembly of claim 16, wherein the external airfoil shell has a nonuniform thickness.

18. The airfoil assembly of claim 16, wherein the spar comprises:
a spar core comprising a second foam to define the spar extending in the first direction; and
an external spar shell on a surface of the spar core, the external spar shell comprising a second metal alloy electroformed on the spar core.

19. The airfoil assembly of claim 18, wherein the external spar shell has a nonuniform thickness.

20. The airfoil assembly of claim 16, wherein the external airfoil shell covers all of the exterior surface of the airfoil core.
